(19) United States
(12) Patent Application Publication
(10) Pub. No.: US 2013/0283061 A1
(43) Pub. Date: Oct. 24, 2013

(54) IMAGE PROCESSING METHOD AND APPARATUS FOR PRIVACY PROTECTION OF CAPTURED IMAGE

(71) Applicant: ELECTRONICS & TELECOMMUNICATIONS RESEARCH INSTIT, Daejeon (KR)

(72) Inventor: Chi Yoon JEONG, Daejeon (KR)

(73) Assignee: Electronics & Telecommunications Research Institute, Daejeon (KR)

(21) Appl. No.: 13/674,703

(22) Filed: Nov. 12, 2012

(30) Foreign Application Priority Data
Apr. 23, 2012 (KR) 10-2012-0041952

(51) Int. Cl. G06F 21/60

(52) U.S. Cl. CPC G06F 21/602
USPC 713/189

(57) ABSTRACT

Provided are an image processing method and method for privacy protection of a captured image. The image processing method divides an original image into a plurality of regions, assigns access privileges to the respective regions, and encrypts the regions, and provides an image by performing masking to each region or provides an image without performing masking, based on the access privilege of an image access request, and achieving privacy protection from the leakage of an original image. Accordingly, when storing a captured PC screen image and providing the stored image, an image region having no relation to a user's activities is stored after hierarchical encryption, preventing privacy infringement.

### CLAIM FOR PRIORITY

This application claims priority to Korean Patent Application No. 10-2012-0041952 filed on Apr. 23, 2012 in the Korean Intellectual Property Office (KIPO), the entire contents of which are hereby incorporated by reference.

### BACKGROUND

1. Technical Field

Example embodiments of the present invention relate in general to an image processing method and apparatus, and more specifically, to an image processing method and apparatus for encrypting a predetermined region of an image and decrypting the encrypted image, based on a privilege of an access requester, for the purpose of privacy protection.

2. Related Art

A data leakage prevention solution is security software that monitors and prevents leakage of important information. A data leakage prevention solution monitors whether files existing in a user's PC move through a USB, a web hard, an email, or a shared folder. When files corresponding to a condition set by a user leak out, a data leakage prevention solution generates an alarm message and stores relevant contents in a database.

In this case, as evidence of information leakage, a captured PC screen image is stored in a database or stored in a file format. In addition to the data leakage prevention solution, a variety of security software, such as software for monitoring a user's activities on a PC, stores a captured PC screen image, and a security manager plays back the relevant image in the process of checking alarm data generated by the security software.

Security software so far does not perform image processing such as masking for privacy protection of a captured PC screen image. Therefore, when a security manager plays back an image, or an image stored in a storage leaks out, privacy-related information also leaks out, increasing the possibility of privacy infringement.

A variety of methods have been developed for privacy protection in images. Most methods hide a previously set region or a specific region checked through image recognition, prior to transmission in a surveillance camera. Such methods are called privacy masking, and privacy infringement may be solved by hiding information sensitive to privacy when the transmitted image is played back in a security control center or the like.

Since a background of a captured PC screen image is atypical, as opposed to an image of an existing surveillance camera, a privacy masking method of setting a specific region in advance may not be applied. Also, since a feature of an important region targeted by an existing surveillance camera is different from a feature of an important region targeted in a captured PC screen image, there is a need for a new method for finding an important region.

### SUMMARY

Accordingly, example embodiments of the present invention are provided to substantially obviate one or more problems due to limitations and disadvantages of the related art.

Example embodiments of the present invention provide an image storing method, as one aspect of an image processing method, which divides an original image into a plurality of regions and encrypts the respective regions to which access privileges are assigned, achieving privacy protection from leakage of the original image.

Example embodiments of the present invention also provide an image providing method, as another aspect of an image processing method, which provides an image by performing masking to each region, or provides an image without performing masking, based on the access privilege of an image access requester, achieving privacy protection from the leakage of an original image.

Example embodiments of the present invention also provide an image storing apparatus, as one aspect of an image processing apparatus, which divides an original image into a plurality of regions and encrypts the respective regions to which access privileges are assigned, achieving privacy protection from the leakage of the original image.

Example embodiments of the present invention also provide an image providing apparatus, as another aspect of an image processing apparatus, which provides an image by performing masking to each region or provides an image without performing masking, based on the access privilege of an image access requester, achieving privacy protection from the leakage of an original image.

In some example embodiments, an image processing method for storing an image constituted by a plurality of regions on which encryption is performed or not performed according to access privileges of the respective regions, includes: receiving an original image; determining a plurality of regions with respect to the received image, and assigning access privileges to the respective regions; encrypting at least a part of the plurality of regions according to the assigned access privileges; and storing regional images of the plurality of regions, the access privileges of the plurality of regions, and information on an encryption key used for encrypting the plurality of regions.

The plurality of regions may be determined by dividing the image into an active window region and a background region.

The plurality of regions may be determined based on at least one of information on programs corresponding to the respective regions and information on window sizes corresponding to the respective regions.

The plurality of regions may be determined by using at least one of status information of a host, which provides the image, and analysis results of the image.

In other example embodiments, an image processing method for providing an image constituted by a plurality of regions to which access privileges are assigned and encryption is performed or not performed according to the access privileges, includes: receiving an image access request; checking the access privilege of the image access request; and based on the access privilege of the access request among the plurality of regions, providing a masked regional image with respect to an inaccessible region, providing a decrypted regional image when an accessible region is encrypted, and providing an original regional image when a region is not encrypted.

The plurality of regions constituting the image may be divided into an active window region and an inactive region.

The plurality of regions may be divided based on at least one of information on programs corresponding to the respective regions and information on window sizes corresponding to the respective regions.

The regional image may be masked by using at least one of a method of displaying the inaccessible region with a mono color, a method of dividing the inaccessible region into small sub-regions and displaying the respective sub-regions with random colors, and a method of converting a color range.

In still other example embodiments, an image processing apparatus for storing an image constituted by a plurality of regions on which encryption is performed or not performed according to access privileges of the respective regions, includes: a region determining unit configured to receive an original image, determine a plurality of regions, and assign access privileges to the respective regions; an encryption processing unit configured to encrypt at least a part of the plurality of regions according to the assigned access privileges; an encryption key managing unit configured to manage an encryption key necessary for encryption by the encryption processing unit; and an image managing/storing unit configured to store and manage regional images of the plurality of regions, the access privileges of the plurality of regions, and information on the encryption key used for encrypting the plurality of regions.

The image processing apparatus may further include an entire image encryption processing unit configured to receive the encryption key from the encryption key managing unit, encrypt the entire received original image, and provide the encrypted original image to the image managing/storing unit, wherein the image managing/storing unit may store the encrypted original image provided from the entire image encryption processing unit.

The region determining unit may determine the plurality of regions by dividing the received original image into an active window region and an inactive region.

The image determining unit may determine the plurality of regions, based on at least one of information on programs corresponding to the respective regions and information on window sizes corresponding to the respective regions.

The region determining unit may determine the plurality of regions by using at least one of status information of a host, which provides the original image, and analysis results of the original image.

In yet other example embodiments, an image processing apparatus for providing an image constituted by a plurality of regions to which access privileges are assigned and encryption is performed or not performed according to the access privileges, includes: an image managing/storing unit configured to store and manage regional images of the plurality of regions and access privileges of the plurality of regions, and receive an image access request from the exterior; a decryption/masking processing unit configured to reconstruct an image, to which access is requested, based on the access privilege of the access request, by using a masked regional image with respect to an inaccessible region among the plurality of regions, a decrypted regional image when an accessible region is encrypted, and an original regional image when an accessible region is not encrypted; an encryption key managing unit configured to manage an encryption key necessary for decryption by the decryption/masking processing unit; and an image providing unit configured to provide the reconstructed image.

The plurality of regions constituting the image may be divided into an active window region and an inactive region.

The plurality of regions constituting the image may be divided based on at least one of information on programs corresponding to the respective regions and information on window sizes corresponding to the respective regions.

The decryption/masking processing unit may perform masking by using at least one of a method of displaying the inaccessible region with a mono color, a method of dividing the inaccessible region into small sub-regions and displaying the respective sub-regions with random colors, and a method of converting a color range.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating an image storing method as an image processing method according to an example embodiment of the present invention;

FIG. 2 is a flowchart illustrating a method for providing an image in response to an image access request as an image processing method according to an example embodiment of the present invention;

FIG. 3 is a conceptual diagram illustrating an example of an image region determination in an image processing method according to an example embodiment of the present invention;

FIG. 4 is a conceptual diagram illustrating masking for each region of an image in an image processing method according to an example embodiment of the present invention;

FIG. 5 is a conceptual diagram illustrating another example of an image region determination in an image processing method according to an example embodiment of the present invention;

FIG. 6 is a block diagram illustrating an image storing apparatus as an image processing apparatus according to an example embodiment of the present invention;

FIG. 7 is a block diagram illustrating a region determining unit constituting an image storing apparatus in an image processing apparatus according to an example embodiment of the present invention; and

FIG. 8 is a block diagram illustrating an image providing apparatus as an image processing apparatus according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the accompanying drawings.

Image Processing Method According to Example Embodiment of the Present Invention

An image processing method according to an example embodiment of the present invention includes an image storing method and an image providing method.

The image storing method is configured to store an image in a plurality of regions on which encryption is performed or not performed according to access privileges of the respective regions. The image providing method is configured to assign access privileges to the respective regions, and process a request to access the image stored in the plurality of regions on which encryption is performed or not performed according to the access privileges.

Typically, the image storing method may be performed by a process of continuously or periodically capturing and storing an image of a PC screen or the like. For example, the image storing method may be performed by security software or the like. The method for providing an image in response to an image access request may be performed by a process of providing a user with a PC screen image captured and stored when information infringement or the like has occurred.

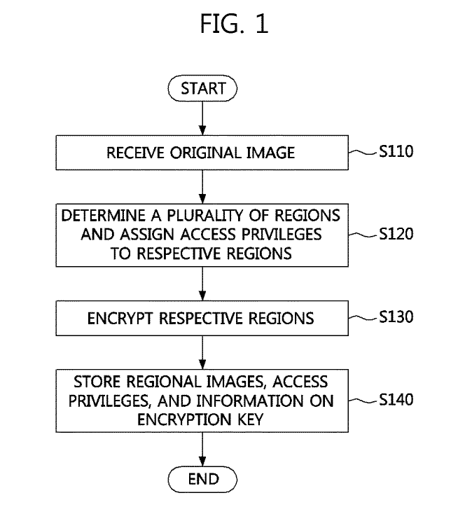

FIG. 1 is a flowchart illustrating an image storing method as an image processing method according to an example embodiment of the present invention.

Referring to FIG. 1, the image storing method according to the example embodiment of the present invention may include: receiving an original image (S 110); determining a plurality of regions with respect to the received original image, and assigning access privileges to the respective regions (S120); encrypting at least a part of the plurality of regions according to the assigned access privileges (S130); and storing regional images of the plurality of regions, the access privileges of the plurality of regions, and information on an encryption key used for encrypting the plurality of regions (S 140).

Operation 5110 is to receive an original image in which an image of a PC screen, a smartphone screen, or a display screen of a terminal is captured. The image used herein may be a still image or one of continuous images constituting a motion picture. That is, the image storing method according to the example embodiment of the present invention can also be applied to motion pictures as well as still images.

Operation 5120 is to determine a plurality of regions with respect to the received image, and assign access privileges to the respective regions.

Determining the plurality of regions with respect to the received image in operation S120 may include dividing the received original image into an active window region and a background region other than the active window region within the entire image.

Alternatively, the entire image may be divided into a plurality of regions, based on at least one of information on programs corresponding to the respective regions (for example, the kind of program, importance of the program, a program executer, and the like) and window sizes corresponding to the respective regions.

The regions may be separated from an input original image by using image feature information of the regions (color, texture, shape). Also, information on a current active window may be received from an operating system of a host having generated the original image, and the regions are separated based on the information received from the host. For example, information indicating the active window may be received from the host by using Application Programming Interface (API) or the like, which searches the active window of the operating system receiving the original image.

Also, when the host is a PC, the active window region may be detected by identifying a current active window icon in a task bar on a PC screen provided by an operating system of the PC and finding a window having the corresponding icon, or the active window region may be detected through image information analysis using position and/or size information. Also, by using information on a process of the host, which is received from the security software, a window corresponding to the relevant process may be found as the active window.

The above-described methods may be used independently or in combination, and apply to the process of determining the regions.

Additionally, in operation S120, the access privileges may be assigned to the found regions. If the found regions are constituted by only two regions, that is, the active window region and the background region, the access privileges are dualistically assigned to the active window region and the background region (for example, when the lowest access privilege of 0 is assigned to the active window region, the highest access privilege of 1 is assigned to the background region). That is, the access privilege of the active window region and the access privilege of the background region are dualistically assigned.

However, the access privileges may be configured hierarchically in various manners. The access privileges may be divided into a plurality of layers with different levels by using information on programs corresponding to the respective regions and information on the window sizes corresponding to the respective regions.

For example, a first-level access privilege may be assigned to a web browser such as Internet Explorer or the like; a second-level access privilege may be assigned to a word processing program or the like; a third-level access privilege may be assigned to programs such as a messenger; and a fourth-level access privilege may be assigned to design programs such as CAD or programming tool programs. This may mean that the higher the level of access privilege, higher privilege is required when accessing the relevant region, or may mean that the lower the level of access privilege, higher privilege is required for browsing the relevant region.

In operation S130, the encryption is performed on at least a part of the plurality of regions according to the assigned access privileges. The encryption used herein means encryption that is performed on the respective regions according to access privileges.

In operation S140, the regional images of the plurality of regions and information for decrypting the encrypted regions are stored. The information for decryption may be a key value used for performing the corresponding encryption, or information on a key used for performing the corresponding encryption. In addition, in operation S140, information on the access privileges assigned to the respective regions may also be stored.

In operation S140, in the case of the regions that need not be encrypted among the plurality of regions (that is, the regions that are accessible by anyone even with the lowest access privilege), the regional images themselves are stored. In the case of the regions that need to be encrypted among the plurality of regions, the encrypted regional images, the encryption key for decryption, and information on the encryption key are stored.

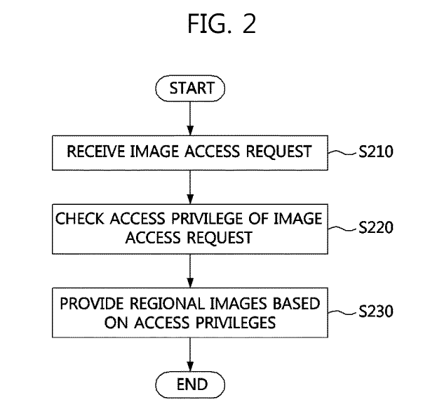

FIG. 2 is a flowchart illustrating a method for providing an image in response to an image access request as an image processing method according to an example embodiment of the present invention.

Referring to FIG. 2, a method for processing an image access request according to an example embodiment of the present invention may include: receiving an image access request (S210); checking the access privilege of the image access request (S220); and providing a masked regional image with respect to an inaccessible region, providing a decrypted regional image in the case where an accessible region is encrypted, and providing an original regional image in the case where a region is not encrypted (S230).

The image requested to be provided in response to the image access request according to the example embodiment of the present invention may be an image stored in a plurality of divided regions having corresponding access privileges, or may be an image stored by the image storing method of FIG. 1 according to the example embodiment of the present invention.

In this case, the plurality of regions constituting the image may be dualistically divided into an active window region or an inactive background region, and be assigned with dualistic access privileges. Also, the plurality of regions constituting the image may be configured in various manners by using information on programs corresponding to the respective regions and information on the window sizes corresponding to the respective regions. That is, the access privileges may be assigned after division into a plurality of layers with different levels.

For example, a first-level access privilege may be assigned to a web browser such as Internet Explorer or the like; a second-level access privilege may be assigned to a word processing program or the like; a third-level access privilege may be assigned to programs such as a messenger; and a fourth-level access privilege may be assigned to design programs such as CAD or programming tool programs. This may mean that the higher the level of access privilege, higher privilege is required for access to the relevant region, or may mean that the lower the level of access privilege, higher privilege is required for access to the relevant region.

Therefore, in operation S210 of receiving the image access request and operation S220 of checking the access privilege of the image access request, an access request for a stored image is received from a user, and the access privilege of a user issuing the received access request is checked by using information included in the access request, or is directly checked by using information of a user sending the access request. In this case, the access privilege of the user may be checked by synthesizing ID of the user, host IP, access privilege, information on the seriousness of an infringement committed, and the like.

In operation S230, based on the access privilege of the access request among the plurality of regions, a masked regional image is provided with respect to an inaccessible region, a decrypted regional image is provided in the case where an accessible region is encrypted, and an original regional image is provided in the case where a region is not encrypted.

The access privilege of the access request received from the user is compared with the access privilege assigned to each region. When the access privilege of the user is higher than or equal to the assigned access privilege, the decrypted image is displayed. On the other hand, when the access privilege of the user is lower than the assigned access privilege, the masked image is displayed.

In this case, since the unencrypted region (that is, the region accessible even with the lowest access privilege) among the regions, in which the access privilege of the user is higher than or equal to the assigned access privilege, is not encrypted, the original regional image is displayed.

In this case, masking for the inaccessible region may be performed by using at least one of a method of displaying the inaccessible region with a mono color, a method of dividing an inaccessible region into small sub-regions and displaying the respective sub-regions with random colors (for example, a mosaic type), and a method of converting a color range (for example, a method of converting an original regional image of 160,000 colors into an image of 256,000 colors). Furthermore, a variety of masking methods may be used to normally display the relevant regional image.

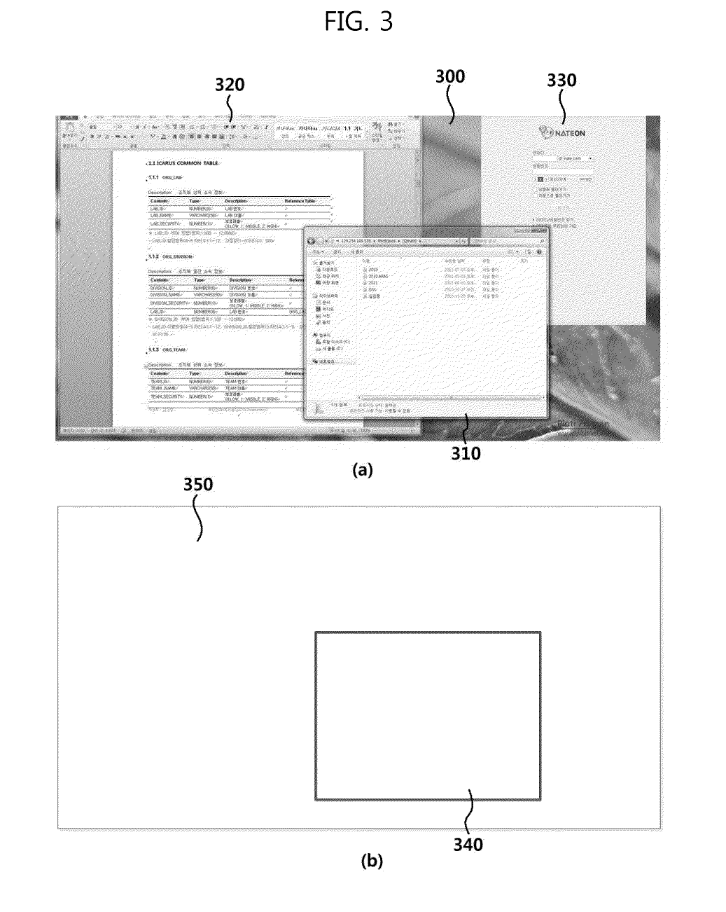

The image processing method of FIGS. 1 and 2 may be described more easily with reference to the conceptual diagrams of FIGS. 3 to 5.

FIG. 3 is a conceptual diagram illustrating an example of an image region determination in an image processing method according to an example embodiment of the present invention.

FIG. 3A illustrates a captured original image 300, including an explorer window 310, a word processor window 320, and a messenger window 330. In this case, the active window is the explorer window 310.

In operation S120 of the image processing method according to the example embodiment of the present invention, when the region is dualistically divided into the active window region and the inactive region, the region is separated into the active window region 340 and the inactive region (background region) 350.

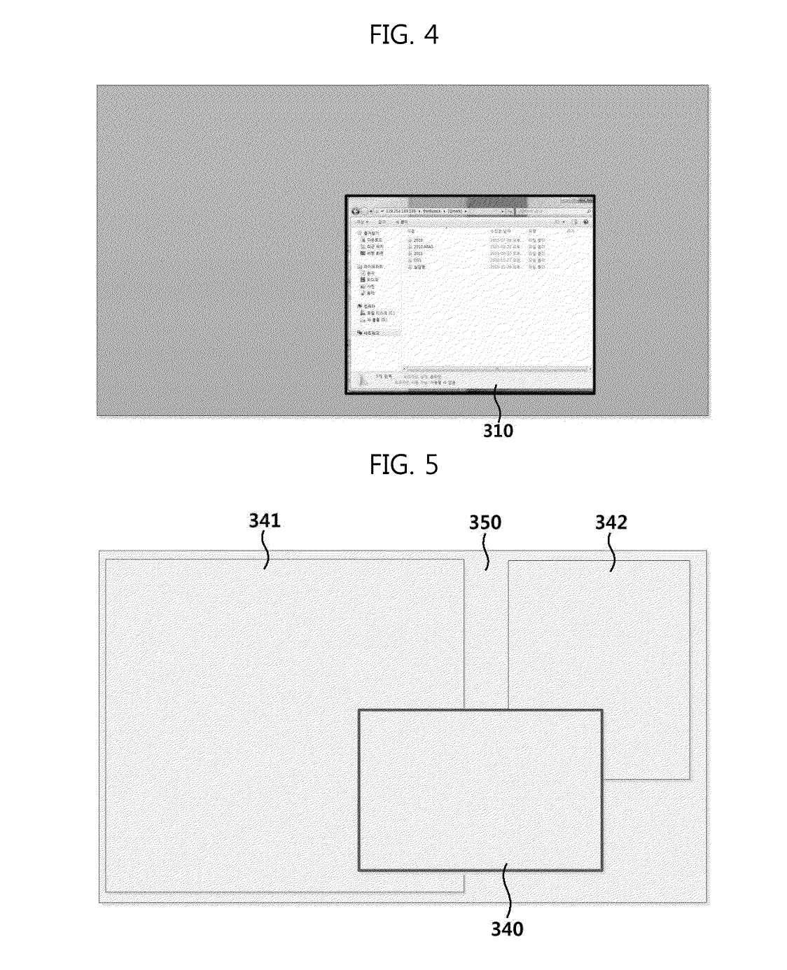

FIG. 4 is a conceptual diagram illustrating a concept of masking for each image region in the image processing method according to the example embodiment of the present invention.

Referring to FIG. 4, in operation S130 of the image processing method according to the example embodiment of the present invention, the inactive region (background region) other than the active window region 310 is encrypted. Referring to FIG. 4, the inactive region other than the active window region is stored after encryption by the image storing method of FIG. 1 according to the example embodiment of the present invention, and the corresponding region is masked by the image providing method of FIG. 2 according to the example embodiment of the present invention (for example, the inactive region is displayed with a mono color). In this case, the masked region is encrypted.

FIG. 5 is a conceptual diagram illustrating another example of an image region determination in the image processing method according to the example embodiment of the present invention.

Meanwhile, FIGS. 3 and 4 illustrate the case where the image is dualistically divided into the active window region and the inactive region. However, as described above, when the access privilege is pluralistically configured (for example, access privileges 1, 2 and 3 are assigned to the explorer, the word processor, and the messenger respectively), the original image may be stored in four divided regions. That is, the region may be divided into the explorer window region 340, the word processor window region 341, the messenger window region 342, and the background region 350.

In this case, in the image providing method according to the example embodiment of the present invention, the remaining regions 342 and 350, except for the explorer window region 340 assigned with access privilege 1 and the word processor region 341 assigned with access privilege 2, are provided to the user having access privilege 2.

Image Processing Apparatus According to Example Embodiment of the Present Invention

In a similar manner to the image processing method described above, an image processing apparatus according to an example embodiment of the present invention may include an image storing apparatus and an image providing apparatus. The image storing apparatus and the image providing apparatus are not a physical division but a functional division. Components of the respective apparatuses, which will be described below, may be included in a single physical apparatus which provides both an image storing function and an image providing function.

The image storing apparatus is configured to store an image in a plurality of regions on which encryption is performed or not performed according to access privileges of the respective regions. The image providing apparatus is configured to assign access privileges to the respective regions and process a request to access the image stored in the plurality of regions on which encryption is performed or not performed according to the access privileges.

Typically, the image storing apparatus may be configured to perform a process of continuously or periodically capturing and storing an image of a PC screen or the like, and to perform a process of providing a user with an image of a PC screen captured and stored when information infringement or the like has occurred.

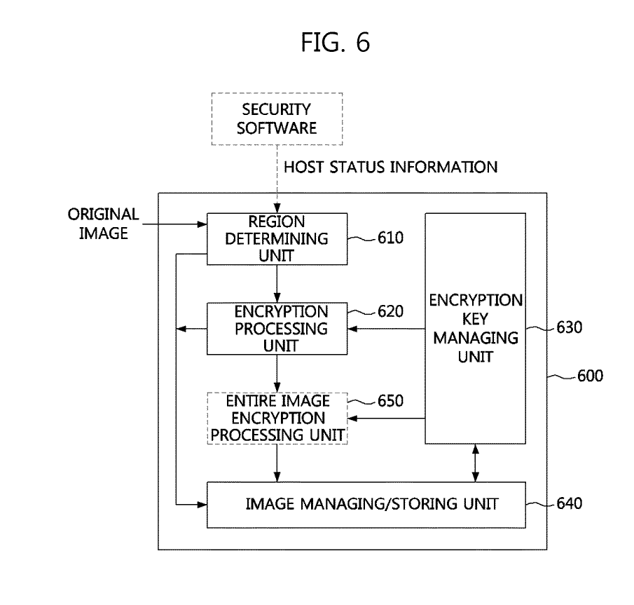

FIG. 6 is a block diagram illustrating an image storing apparatus as an image processing apparatus according to an example embodiment of the present invention.

Referring to FIG. 6, the image storing apparatus 600 according to the example embodiment of the present invention may include a region determining unit 610, an encryption processing unit 620, an encryption key managing unit 630, and an image managing/storing unit 640. The image storing apparatus according to the example embodiment of the present invention may further include an entire image encryption processing unit 650 configured to encrypt the entire received original image, and store the encrypted image.

The region determining unit 610 receives the original image (captured image), determines a plurality of regions with respect to the received original image, and assigns access privileges to the respective regions. Also, the region determining unit 610 may additionally receive host status information of a process or the like, which is activated when capturing an image of a PC screen, from security software (DLP or the like) monitoring a PC. The region determining unit 610 functions to detect an active window by using the host status information and the information of the captured PC screen image. The information of the activated process, provided from the security software, is additional information. When there is no information of the process, the active window may be detected through image information analysis using the information of the captured PC screen image only.

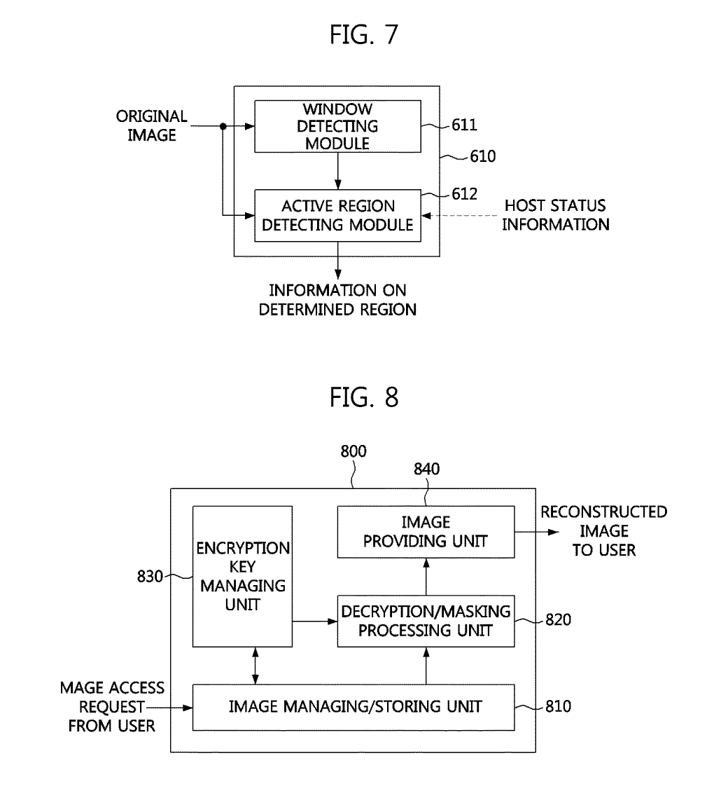

FIG. 7 is a block diagram illustrating the region determining unit constituting the image storing apparatus in the image processing apparatus according to the example embodiment of the present invention.

Referring to FIG. 7, the region determining unit 610 may include a window detecting module 611 and an active region detecting module 612.

The window detecting module 611 functions to divide a PC screen into window regions generated for respective programs by using image feature information (color, texture, shape, etc.)

The active region detecting module 612 may detect an active window by using image information analysis, which identifies a currently activated window icon in a task bar of a PC screen, and finds a window having the corresponding icon by using position and/or size information, or may detect a window corresponding to the corresponding process as an active window by using host process information received from security software.

The region determining unit 610 may independently operate the two modules 611 and 612, or may operate the two modules 611 and 612 in parallel to detect the active window region and the inactive region more precisely.

Meanwhile, the region determining unit 610 may divide the original image into only two regions, that is, the active window region and the inactive background region. However, as described above, the plurality of regions constituting the image may be determined in various manners by using information on programs corresponding to the respective regions, and information on window sizes corresponding to the respective regions. In this case, the access privileges may be assigned after division into a plurality of layers with different levels. For example, a first-level access privilege may be assigned to a web browser such as Internet Explorer or the like; a second-level access privilege may be assigned to a word processing program or the like; a third-level access privilege may be assigned to programs such as a messenger; and a fourth-level access privilege may be assigned to design programs such as CAD or programming tool programs. This may mean that the higher the level of access privilege, higher privilege is required for access to the relevant region, or may mean that the lower the level of access privilege, higher privilege is required for access to the relevant region.

The encryption processing unit 620 is an element that encrypts at least a part of the plurality of regions according to the assigned access privileges.

The encryption processing unit 620 encrypts at least a part of the plurality of regions according to the assigned access privileges. The encryption used herein means encryption that is performed on the respective regions according to the access privileges.

The encryption key managing unit 630 is an element that manages an encryption key necessary for encryption by the encryption processing unit 620.

The image managing/storing unit 640 is an element that stores and manages the plurality of regions and the access privileges of the plurality of regions. That is, the image managing/storing unit 640 stores the regional images of the plurality of regions and information for decrypting the encrypted regions. The information for decryption may be a key value used for performing the corresponding encryption, or information on a key used for performing the corresponding encryption. Furthermore, the image managing/storing unit 640 may also store information on the access privileges assigned to the respective regions.

In the case of the regions that need not be encrypted among the plurality of regions (that is, the regions that are accessible by anyone even with the lowest access privilege), the image managing/storing unit 640 stores the regional images themselves. In the case of the regions that need to be encrypted among the plurality of regions, the image managing/storing unit 640 stores the encrypted regional images, the encryption key for decryption, and information on the encrypted key. In this case, the image managing/storing unit 640 may include various types of storage, such as a file and a database.

The entire image encryption processing unit 650 receives the encryption key from the encryption key managing unit 630 and encrypts the entire received image. Since the entire image is encrypted and then stored, it is possible to prevent privacy infringement caused by information leakage of the image managing/storing unit 640 storing the image data.

That is, the entire image encryption processing unit 640 receives the encryption key from the encryption key managing unit, encrypts the image in which regions other than the region having the lowest access privilege are masked, and transfers the encrypted images to the image managing/storing unit 640. As such, since the images are encrypted and then stored, privacy infringement does not occur even though information of the image storage leaks out.

FIG. 8 is a block diagram illustrating an image providing apparatus as an image processing apparatus according to an example embodiment of the present invention.

Referring to FIG. 8, the image providing apparatus 800 according to the example embodiment of the present invention may include an image managing/storing unit 810, a decryption/masking processing unit 820, an encryption key managing unit 830, and an image providing unit 840.

The image managing/storing unit 810 is an element that stores and manages a plurality of regions and access privileges of the plurality of regions, and receives an image access request from the exterior (in most cases, a user or manager who sends a request to provide an image).

Based on the access privilege of the access request, the decryption/masking processing unit 820 is an element that reconstructs an image, to which access is requested, by using a masked regional image with respect to an inaccessible region among the plurality of regions, a decrypted regional image in the case where an accessible region is encrypted, and an original regional image in the case where an accessible region is not encrypted.

In this case, the access privilege of the access request checks the access privilege of the user who sends the access request received in the image managing/storing unit 810 by using information included in the access privilege, or directly checks the access privilege of the user by using information of the user who sends the access request. In this case, the access privilege of the user may be checked by synthesizing ID of the user, host IP, access privilege, information on the seriousness of an infringement committed, and the like.

The encryption key managing unit 830 is an element that manages an encryption key necessary for decryption by the decryption/masking processing unit 820.

The image providing unit 840 is an element that finally provides the user with the image reconstructed in the decryption/masking processing unit 820.

According to the example embodiments of the present invention, when storing a captured PC screen image, an image region having no relation to a user's activities is stored after hierarchical encryption, preventing privacy infringement.

Also, window regions for programs are identified from a captured PC screen image by using image feature information (color, texture, shape, etc.), and an active window region is found. Therefore, privacy masking may be automatically performed without manager intervention.

In addition, in the case where a manager makes a request to provide image information, after analyzing ID of an image information requester, host IP, access privilege, information on the seriousness of an infringement committed, and the like, it is automatically determined whether to transmit an image with a masked background region or an original image, and the relevant image is transmitted to the manager. Therefore, privacy infringement may be effectively prevented.

Moreover, an image is divided into a plurality of layers with different levels by using the size of an active window, program information, and the like, and masking is applied to each layer. Therefore, it is possible to provide an image masked more precisely according to manager privilege.

While the example embodiments of the present invention and their advantages have been described in detail, it should be understood that various changes, substitutions and alterations may be made herein without departing from the scope of the invention.

What is claimed is:

1. An image processing method for storing an image constituted by a plurality of regions on which encryption is performed or not performed according to access privileges of the respective regions, the image processing method comprising:
receiving an original image;
determining a plurality of regions with respect to the received image, and assigning access privileges to the respective regions;
encrypting at least a part of the plurality of regions according to the assigned access privileges; and
storing regional images of the plurality of regions, the access privileges of the plurality of regions, and information on an encryption key used for encrypting the plurality of regions.

2. The image processing method of claim 1, wherein the plurality of regions are determined by dividing the image into an active window region and a background region.

3. The image processing method of claim 1, wherein the plurality of regions are determined based on at least one of information on programs corresponding to the respective regions and information on window sizes corresponding to the respective regions.

4. The image processing method of claim 1, wherein the plurality of regions are determined by using at least one of status information of a host, which provides the image, and analysis results of the image.

5. An image processing method for providing an image constituted by a plurality of regions to which access privileges are assigned and encryption is performed or not performed according to the access privileges, the image processing method comprising:
receiving an image access request;
checking the access privilege of the image access request; and
based on the access privilege of the access request among the plurality of regions, providing a masked regional image with respect to an inaccessible region, providing a decrypted regional image when an accessible region is encrypted, and providing an original regional image when a region is not encrypted.

6. The image processing method of claim 5, wherein the plurality of regions constituting the image are divided into an active window region and an inactive region.

7. The image processing method of claim 5, wherein the plurality of regions are divided based on at least one of information on programs corresponding to the respective regions and information on window sizes corresponding to the respective regions.

8. The image processing method of claim 5, wherein the regional image is masked by using at least one of a method of displaying the inaccessible region with a mono color, a method of dividing the inaccessible region into small sub-regions and displaying the respective sub-regions with random colors, and a method of converting a color range.

9. An image processing apparatus for storing an image constituted by a plurality of regions on which encryption is performed or not performed according to access privileges of the respective regions, the image processing apparatus comprising:
a region determining unit configured to receive an original image, determine a plurality of regions, and assign access privileges to the respective regions;
an encryption processing unit configured to encrypt at least a part of the plurality of regions according to the assigned access privileges;
an encryption key managing unit configured to manage an encryption key necessary for encryption by the encryption processing unit; and
an image managing/storing unit configured to store and manage regional images of the plurality of regions, the access privileges of the plurality of regions, and information on the encryption key used for encrypting the plurality of regions.

10. The image processing apparatus of claim 9, further comprising an entire image encryption processing unit configured to receive the encryption key from the encryption key managing unit, encrypt the entire received original image, and provide the encrypted original image to the image managing/storing unit,
wherein the image managing/storing unit stores the encrypted original image provided from the entire image encryption processing unit.

11. The image processing apparatus of claim 9, wherein the region determining unit determines the plurality of regions by dividing the received original image into an active window region and an inactive region.

12. The image processing apparatus of claim 9, wherein the image determining unit determines the plurality of regions, based on at least one of information on programs corresponding to the respective regions and information on window sizes corresponding to the respective regions.

13. The image processing apparatus of claim 9, wherein the region determining unit determines the plurality of regions by using at least one of status information of a host, which provides the original image, and analysis results of the original image.

14. An image processing apparatus for providing an image constituted by a plurality of regions to which access privileges are assigned and encryption is performed or not performed according to the access privileges, the image processing apparatus comprising:
an image managing/storing unit configured to store and manage regional images of the plurality of regions and access privileges of the plurality of regions, and receive an image access request from the exterior;
a decryption/masking processing unit configured to reconstruct an image, to which access is requested, based on the access privilege of the access request, by using a masked regional image with respect to an inaccessible region among the plurality of regions, a decrypted regional image when an accessible region is encrypted, and an original regional image when an accessible region is not encrypted;
an encryption key managing unit configured to manage an encryption key necessary for decryption by the decryption/masking processing unit; and
an image providing unit configured to provide the reconstructed image.

15. The image processing apparatus of claim 14, wherein the plurality of regions constituting the image are divided into an active window region and an inactive region.

16. The image processing apparatus of claim 14, wherein the plurality of regions constituting the image are divided based on at least one of information on programs corresponding to the respective regions and information on window sizes corresponding to the respective regions.

17. The image processing apparatus of claim 14, wherein the decryption/masking processing unit performs masking by using at least one of a method of displaying the inaccessible region with a mono color, a method of dividing the inaccessible region into small sub-regions and displaying the respective sub-regions with random colors, and a method of converting a color range.
